(19) United States
(12) Patent Application Publication
(10) Pub. No.: US 2011/0104584 A1
(43) Pub. Date: May 5, 2011

(54) METAL SUPPORTED SOLID OXIDE FUEL CELL

(75) Inventors: Joongmyeon BAE, Daejeon (KR); Seung-Wook Baek, Daejeon (KR); Changbo Lee, Daejeon (KR); Gyujong Bae, Daejeon (KR); Jaehwa Jeong, Daejeon (KR); Yu-Mi Kim, Daejeon (KR)

(73) Assignee: KOREA ADVANCED INSTITUTE OF SCIENCE AND TECHNOLOGY, Daejeon (KR)

(21) Appl. No.: 12/612,940

(22) Filed: Nov. 5, 2009

(51) Int. Cl. H01M 8/10

(52) U.S. Cl. 429/495

(57) ABSTRACT

Provided is a metal supported solid oxide fuel cell in which a metal supported cell formed at one side or both sides of a unit cell is directly welded to a separation plate so as to achieve sealing therebetween, thereby preventing fuel gas and air from being leaked or mixed before reaction, and the fuel gas and air are supplied through each assigned passage so as to increase energy production efficiency and also remarkably enhance durability and sealing efficiency. The metal supported SOFC includes a unit cell 110 which comprising an electrolyte layer 111, and an anode 112 and a cathode 113 formed at both surface of the electrolyte layer 111; a metal supporter 120 which is formed at one side of the unit cell 110; a first current collecting member 170 which is provided at the other side of the unit cell 110; and first and second separation plates 130a and 130b which respectively have a supplying passage 132b for supplying air to the cathode 113 and a supplying passage 132a for supplying fuel gas to an anode 112, and which are coupled with each other so that the metal supporter 120, the unit cell 110 and the current collecting member 170 are disposed therebetween, wherein the metal supporter 120 is welded to the first or second separation plates 130a or 130b.

### TECHNICAL FIELD

The present invention relates to a metal supported solid oxide fuel cell; and, more particularly, to a metal supported solid oxide fuel cell in which a metal supported cell formed at one side or both sides of a unit cell is directly welded to a separation plate so as to achieve sealing therebetween, thereby preventing fuel gas and air from being leaked or mixed before reaction, and the fuel gas and air are supplied through each assigned passage so as to increase energy production efficiency and also remarkably enhance durability and sealing efficiency.

### BACKGROUND ART

A fuel cell, which is a cell directly converting chemical energy produced by oxidation into electrical energy, is a new next-generation eco-friendly energy technology generating electrical energy from materials abundantly existing on earth, such as hydrogen and oxygen.

In the fuel cell, oxygen is supplied to a cathode and hydrogen is supplied to an anode so that an electrochemical reaction using a reverse reaction of electrolysis of water is performed, thereby producing electricity, heat and water. As a result, the fuel cell produces electrical energy at high efficiency without leading to pollution.

Such the fuel cell has various advantages that it is free from a limitation of Carnot Cycle acting as a limit in a conventional heat engine so that its efficiency can be increased above 40%, it discharges only water as an emission as described above so that there is no a risk of pollution, and it does not need mechanically moving parts so that it can be compacted and does not generate noise, and the like. Therefore, various technologies and studies associated with the fuel cell have actively been progressed.

Six kinds of fuel cells, such as a phosphoric acid fuel cell (PAFC), a molten carbonate fuel cell (MCFC), a solid oxide fuel cell (SOFC), a polymer electrolyte membrane fuel cell (PEMFC), a direct methanol fuel cell (DMFC), and an alkaline fuel cell (AFC) according to kinds of electrolytes have been put to practical use or have been in contemplation. Features of each fuel cell are arranged in the following table.

| Division | PAFC | MCFC | SOFC | PEMFC | DMFC | AFC |
|---|---|---|---|---|---|---|
| Electrolyte | Phosphoric | Lithium | Zirconia/ | Hydrogen | Hydrogen | Potassium |
| | acid | carbonate/ | Ceria system | Ion | Ion | hydroxide |
| | | Potassium | | exchange | exchange | |
| | | carbonate | | Membrane | Membrane | |
| Ion | Hydrogen | Carbonate | Oxygen | Hydrogen | Hydrogen | Hydrogen |
| conductor | ion | ion | ion | ion | ion | ion |
| Operating | 200 | 650 | 500~1000 | <100 | <100 | <100 |
| tempera- | | | | | | |
| ture(° C.) | | | | | | |
| Fuel | Hydrogen | Hydrogen, | Hydrogen, | Hydrogen | Methanol | Hydrogen |
| | | Carbon | Hydrocarbon, | | | |
| | | monoxide | Carbon | | | |
| | | | monoxide | | | |
| Fuel raw | City gas, | City gas, | City gas, | Methanol, | Methanol | Hydrogen |
| material | LPG | LPG, Coal | LPG, | methane | | |
| | | | Hydrogen | gasoline, | | |
| | | | | Hydrogen | | |
| Efficien- | 40 | 45 | 45 | 45 | 30 | 40 |
| cy(%) | | | | | | |
| Output | 100-5000 | 1000-1000000 | 100-100000 | 1-10000 | 1-100 | 1-100 |
| range(W) | | | | | | |
| Main use | Distributed | Large scale | small/middle/ | Power for | Portable | Power |
| | generation | generation | largescale | transporta- | power | supply |
| | type | | | tion | supply | for |
| | | | generation | | | Spaceship |
| Development | Verification- | Test- | Test- | Test- | Test- | Application |
| stage | commercialization | verification | verification | verification | verification | to spaceship |

As appreciated from the table, each fuel cell has various output ranges and uses, etc. so that suitable fuel cells can be selected according to an object. Among them, since the solid oxide fuel cell (SOFC) has advantages in that there is no danger of an exhaustion of an electrolyte because a position of the electrolyte is easily controlled and the position of the electrolyte is fixed and also it has a long life span due to low corrosiveness, as compared to other fuel cells, the effective value of the SOFC is very large in that it is applicable to distributed generation, commerce and home use.

Reviewing the concept view of the operating principle of the SOFC, oxygen is supplied to the cathode and hydrogen is supplied to the anode. At this time, the reaction depends on the following formula.

Anode reaction: 2H₂+2O²→2H₂O+4e⁻

Cathode reaction: O₂+4e⁻→2O²⁻

In the SOFC, typically, yttria-stabilized zirconia (YSZ) is used as the electrolyte, a Ni-YSZ cermet is used as the cathode, a perovskite material is used as the anode, and oxygen ions are used as mobile ions.

FIG. 1 is a schematic view of a conventional solid oxide fuel cell (SOFC) 1. The conventional SOFC 1 includes a unit cell 10 having an electrolyte layer 11, and an anode 12 and an cathode 13 which are formed at both sides of the electrolyte layer 11; a current collecting member 20 which is provided at both sides of the unit cell 10; and a separation plate 30a, 30b in which the unit cell 10 and the current collecting member 20 are provided.

The separation plate 30a, 30b supports the unit cell 10 and the current collecting member 20 and, at the same time, has a supplying passage 31a, 31b for supplying fuel gas and air (oxygen).

Meanwhile, in the SOFC 1, the fuel gas and air has to be flowed through only assigned passages. If the fuel gas and air are mixed with each other or leaked to an outside, the performance of the cell is considerably deteriorated. Therefore, a high level of sealing technology is required.

However, in the conventional SOFC, a glass-based sealant 40 is used in bonding between the separation plates 30a and 30b and bonding between the unit cell 10 and the separation plates 30a and 30b. (FIG. 1 shows an example that a cathode side of the unit cell 10 is bonded with the upper separation plate 30b using the sealant 40).

However, since the glass-based sealant 40 is easily broken by an external impact, it is difficult to have a sufficient strength. Also, since the glass-based sealant 40 is easily deformed by repeated changes in temperature, it is difficult to obtain a sufficient sealing performance. These problems are major causes for the performance deterioration of the SOFC.

Further, the current collecting member 20 is provided between the unit cell 10 and the separation plate 30a, 30b so as to enhance an electrical performance, and formed into a mesh formed of a metal alloy or a noble metal. The current collecting member 20 functions to uniformly supply the fuel gas and air to the unit cell 10. However, sealing ability is deteriorated due to the mesh type current collecting member 20, and current collecting efficiency is also lowered.

Meanwhile, only a signal unit cell module is not sufficient to obtain an enough voltage, and thus it is necessary to increase a surface area of the unit cell 10, or if necessary, multiple unit cells are stacked and then used. However, in this case, it is difficult to satisfy required mechanical strength and enough sealing feature.

### DISCLOSURE

### Technical Problem

An embodiment of the present invention is directed to providing a metal supported solid oxide fuel cell in which a metal supporter having a hollow portion, instead of a mesh type current collecting member, is directly welded to a separation plate such that fuel gas and air can be supplied through each assigned passage to a unit cell without being mixed with each other or leaked to an outside, thereby providing excellent sealing ability and sufficient mechanical strength.

### Technical Solution

To achieve the object of the present invention, the present invention provides a metal supported SOFC including a unit cell 110 which comprising an electrolyte layer 111, and an anode 112 and a cathode 113 formed at both surface of the electrolyte layer 111; a metal supporter 120 which is formed at one side of the unit cell 110; a first current collecting member 170 which is provided at the other side of the unit cell 110; and first and second separation plates 130a and 130b which respectively have a supplying passage 132b for supplying air to the cathode 113 and a supplying passage 132a for supplying fuel gas to an anode 112, and which are coupled with each other so that the metal supporter 120, the unit cell 110 and the current collecting member 170 are disposed therebetween, wherein the metal supporter 120 is welded to the first or second separation plates 130a or 130b.

Preferably, the metal supporter 120 has a welding portion 121 which is formed into a plate type and of which an outer circumference is welded to the first or second separation plate 130a or 130b, and a hollow portion 122 which is hollowed upward and downward at an inside of the welding portion 121 so that fuel gas or air introduced through a supplying passage 132a, 132b of the first or second separation plate 130a or 130b is supplied to the unit cell 110.

Preferably, the first or second separation plate 130a or 130b has a receiving portion 131 formed at an upper side of the supplying passage 132a, 132b that the metal supporter 120 is formed, so as to be inwardly stepped.

Preferably, the metal supporter 120 forms a path through which the hollow portion 122 is communicated with the supplying passage 132a, 132b of the first or second separation plate 130a, 130b, and the hollow portion 122 is formed in plural.

Preferably, the metal supported SOFC further includes an insulating member 140 provided at a portion that the first and second separation plates 130a and 130b are contacted with each other.

Preferably, the metal supported SOFC further includes a second current collecting member 171 between the metal supporter 120 and the first or second separation plate 130a or 130b.

Preferably, the metal supported SOFC 100 is stacked and formed into a stack type.

### ADVANTAGEOUS EFFECTS

According to the metal supported SOFC of the present invention, the metal supporter having the hollow portion, instead of a mesh type current collecting member, is directly welded to a separation plate such that fuel gas and air can be supplied through each assigned passage to a unit cell without being mixed with each other or leaked to an outside, thereby providing excellent sealing ability, high and stable energy production efficiency, sufficient mechanical strength and durability.

### BEST MODE

Hereinafter, a metal supported SOFC according to the present invention having the above-mentioned features will be described with reference to the accompanying drawings.

FIGS. 2, 3a and 3b are an exploded perspective, a cross-sectional view and an exploded cross-sectional view of a metal supported SOFC 100 in accordance with the present invention,

FIG. 4 is a view of a separation plate 130a, 130b of the metal supported SOFC 100 in accordance with the present invention,

FIG. 5 is an exploded cross-sectional view of the metal supported SOFC 100 in accordance with the present invention, FIG. 6 is other exploded cross-sectional view of the metal supported SOFC 100 in accordance with the present invention, and FIG. 7 is a schematic view of a stack type metal supported SOFC 100 in accordance with the present invention.

The metal supported SOFC 100 of the present invention includes a unit cell 110, a metal supporter 120, a first current collecting member 170, a first separation plate 130a and a second separation plate 130b. The metal supporter 120 is welded to the first or second separation plate 130a or 130b.

The unit cell 110 includes an electrolyte layer 111, and an anode 112 and a cathode 113 formed at both sides of the electrolyte layer 111.

The drawings show an example that the anode 112, the electrolyte layer 111 and cathode 113 are formed in turn from a lower side toward an upper side.

The metal supporter 120 is formed at one side of the unit cell 110 so as to support the unit cell 110 and enhance current collecting efficiency, and formed into a plate type. The metal supporter 120 has a welding portion 121 which is welded to the first or second separation plate 130a or 130b, and a hollow portion 122 which is hollowed upward and downward at an inside of the welding portion 121 so that fuel gas or air introduced through a supplying passage 132a, 132b (in case of the first separation plate 130a formed to be adjacent to the anode 112, the supplying passage 132a for the fuel gas, and in case of the second separation plate 130b formed to be adjacent to the cathode 113, the supplying passage 132b) of the first or second separation plate 130a or 130b is supplied to the unit cell 110.

The metal supporter 120 functions to support the unit cell 110 and has enough mechanical strength and heat resistance to prevent deformation due to welding heat. The metal supporter 120 may be formed of a conductive metal or metal alloy.

The first and second separation plates 130a and 130b are a unit body of the metal supported SOFC 100 and respectively have the supplying passage 132b for supplying air to the cathode 113 and the supplying passage 132a for supplying fuel gas to the anode 112. The first and second separation plates 130a and 130b are formed in pair to be coupled with each other, so that the unit cell 110, the first current collecting member 170 and the metal supporter 120 are included therebetween.

The drawings show an example that the first and second separation plates 130a and 130b respectively have fixing parts 133 corresponding to each other at corner portions thereof so as to be simultaneously fixed by a separate coupling member, and the supplying passage 132a, 132b is formed at each of them.

In FIG. 2, the first separation plate 130a has four holes for supplying the fuel gas and the supplying passage 132a having a continuous path. However, the number and shape of the holes and a shape of a protrusion portion forming the path may be formed variously.

FIG. 4 shows other shape of the supply passage 132a, 132b of the first or second separation plate 130a or 130b to which the metal supporter 120 is welded. FIG. 4a shows an example that the supplying passage 132a, 132b has the same shape as that of FIG. 2, but a receiving portion 131 in which the metal supporter 120 is received is not formed.

Further, FIG. 4b shows an example that a protrusion portion having a circular shape in section is formed so as to create a turbulence flow of the fuel gas, and the hole is formed to be longer than that of FIG. 4a.

The present can use other type of the first and second separation plates 130a and 130b having various shapes of the supplying passage 132a, 132b besides those shown in the drawings.

The receiving portion 131 is formed only at the first or second separation plate 130a or 130b contacted with the metal supporter 120. Herein, the receiving portion 131 is formed to be inwardly stepped so that an upper surface of the first or second separation plate 130a or 130b and an upper surface of the metal supporter 120 are on the same plane. Therefore, the upper surface of the first or second separation plate 130a or 130b and the metal supporter 120 are facilely welded to each other.

In the present invention, the welding may include a brazing operation as well as laser welding, argon welding and the like.

Further, in the metal supported SOFC 100 of the present invention, when the metal supporter 120 is welded to the first or second separation plate 130a or 130b, a metal supported cell as a unit body in which the unit cell 110 and the metal supporter 120 may be bonded to each other is firstly formed, and then the metal supporter 120 and the first or second separation plate 130a or 130b may be welded to each other. Otherwise, the metal supporter 120 and the first or second separation plate 130a or 130b may be firstly welded to each other, and then the unit cell 110 may be bonded.

FIGS. 2 to 3b show an example that the metal supporter 120 is welded to a side (a lower side of the drawing) of the first separation plate 130a where the anode 112 is formed. Therefore, since the fuel gas introduced through the supplying passage 132a of the first separation plate 130a is supplied through only a hollow portion 122 of the metal supporter 120, it is possible to solve the problem that the fuel gas is leaked through a conventional assigned passage as well as an outer circumferential portion that the first separation plate 130a and the metal supporter 120 (maybe the current collecting member 170 or the unit cell 110), thereby deteriorating the energy production efficiency.

Further, in the metal supported SOFC 100 of the present invention, since the metal supporter 120 has a conductive property and is also formed of a material having a desired strength, it is possible to certainly support the unit cell 110 and also increase the mechanical strength, thereby increasing the durability.

The first current collecting member 170 having the conductive property is provided between the first or second separation plate 130a or 130b and other surface of the unit cell 110, i.e., other side thereof that the metal supporter 120 of the unit cell 110 is not formed. Preferably, the first current collecting member 170 is formed into a porous type or a mesh type so that the fuel gas or air introduced through the supplying passage 132a, 132b of the first or second separation plate 130a or 130b.

In the metal supported SOFC 100 of the present invention, an insulating member 140 has to be provided at a portion that the first and second separation plates 130a and 130b are contacted with each other. A glass-based sealant having insulation property may be used as the insulating member 140. However, in order to enhance the durability and workability, a plate type insulating member may be used as described in the drawings.

The insulating member 140 shown in the drawings is hollowed so as to receive the unit cell 110. Preferably, insulating member 140 has the same height as the unit cell 110 and the first current collecting member 170 included therein so that the metal supporter 120, the unit cell 110, the first current collecting member 170, the first separation plate 130a and the second separation plate 130b are fixed to be closely contacted with each other. In case that the fixing portion 133 is formed at each corner portion of the first and second separation plates 130a and 130b, and a separate member is fixedly inserted therein, it is preferable that the insulating member 140 also has a fixing portion 141 corresponding to the fixing portions 133 of the first and second separation plates 130a and 130b so as to be fixed together with the first and second separation plates 130a and 130b.

In the metal supported SOFC 100 shown in FIG. 5, the second current collecting member 171 is provided between the metal supporter 120 and the first separation plate 130a which has the receiving portion 131 formed toward one side (anode side) of the unit cell 110, and the first separation plate 130a and the metal supporter 120 are welded to each other, and the current collecting member 170 is formed between the second separation plate 130b and the other side (cathode side) of the unit cell 110. The metal support 120 and the first separation plate 130a are welded to each other.

In the metal supported SOFC 100 shown in FIG. 6, the receiving portion 131 is formed toward one side of the unit cell 110 that the cathode 113 is formed, and the metal supporter 120 is welded to the second separation plate 130b.

Meanwhile, the metal supported SOFC 100 may be stacked and formed into a stack type which is stably supported by an end plate 150 and a coupling member 160.

Furthermore, in FIG. 7, the first separation plate 130a is welded to the side of the metal supporter 120 that the anode 112 of the unit cell 110 is formed. However, the present invention may have various types. The first and second separation plates 130a and 130b which are formed at a middle portion of the stacked cells so as to respectively support other unit cells may be formed integrally with each other.

While the present invention has been described with respect to the specific embodiments, it will be apparent to those skilled in the art that various changes and modifications may be made without departing from the spirit and scope of the invention as defined in the following claims.

### DESCRIPTION OF DRAWINGS

FIG. 1 is a schematic view of a conventional solid oxide fuel cell (SOFC).

FIGS. 2, 3a and 3b are an exploded perspective, a cross-sectional view and an exploded cross-sectional view of a metal supported SOFC in accordance with the present invention.

FIG. 4 is a view of a separation plate of the metal supported SOFC in accordance with the present invention.

FIG. 5 is an exploded cross-sectional view of the metal supported SOFC in accordance with the present invention.

FIG. 6 is other exploded cross-sectional view of the metal supported SOFC in, accordance with the present invention.

FIG. 7 is a schematic view of a stack type metal supported SOFC in accordance with the present invention.

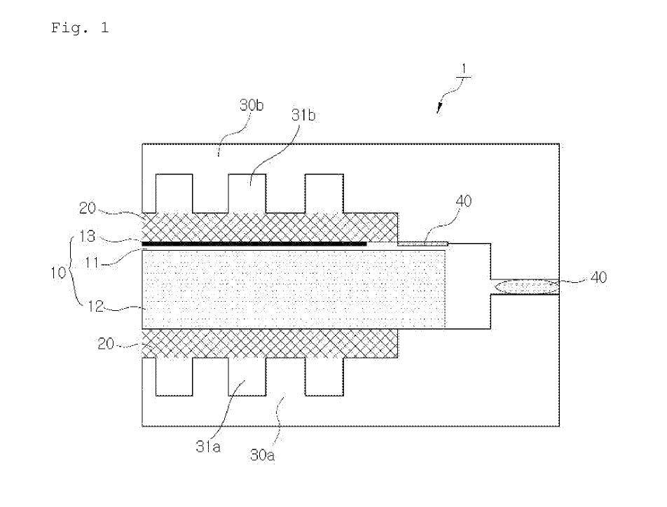

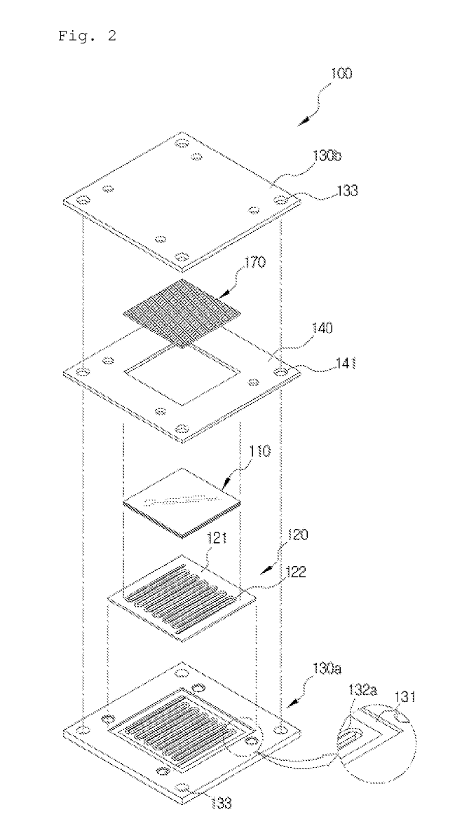

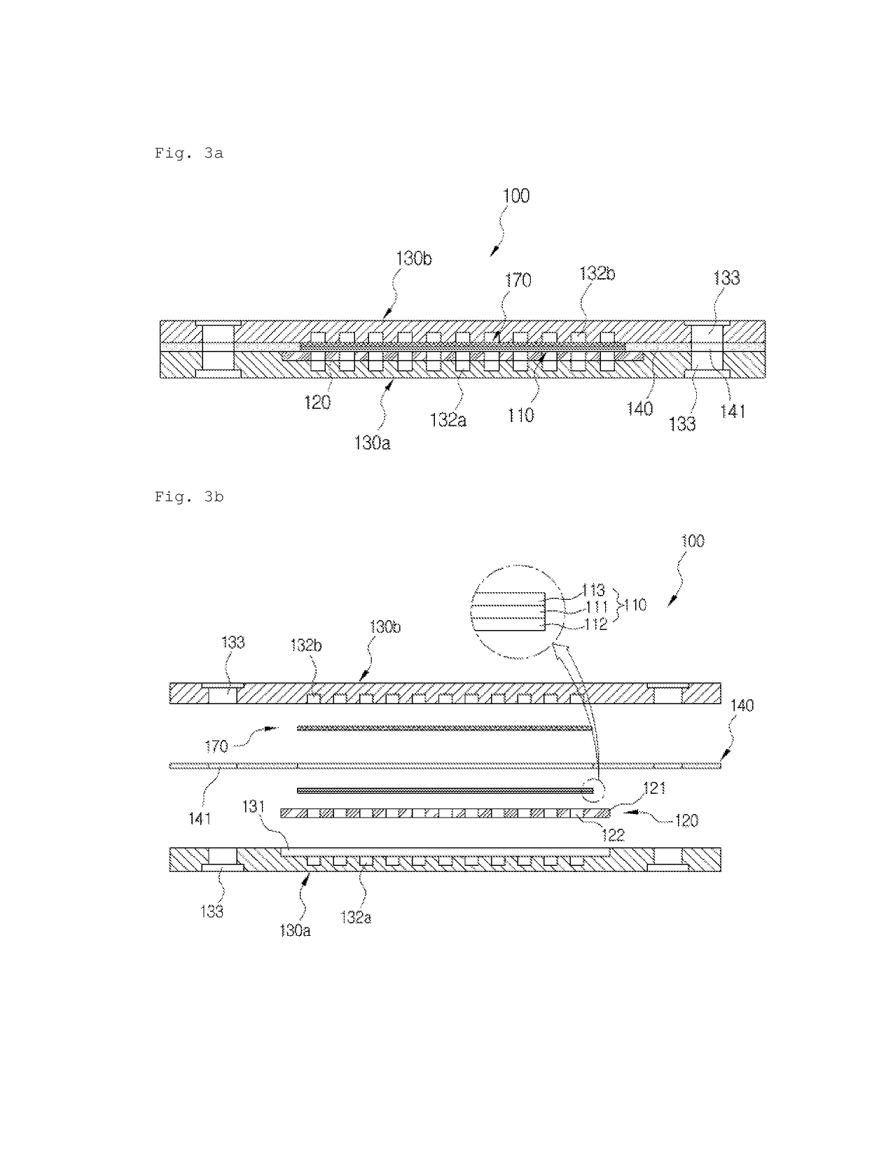

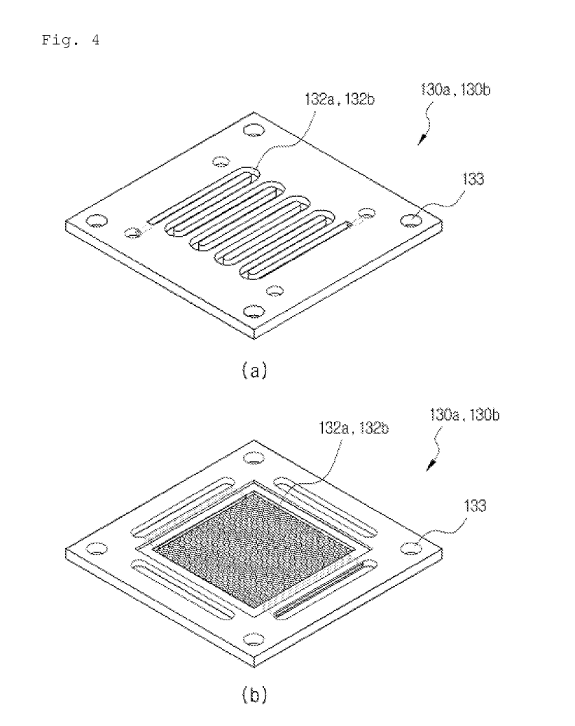

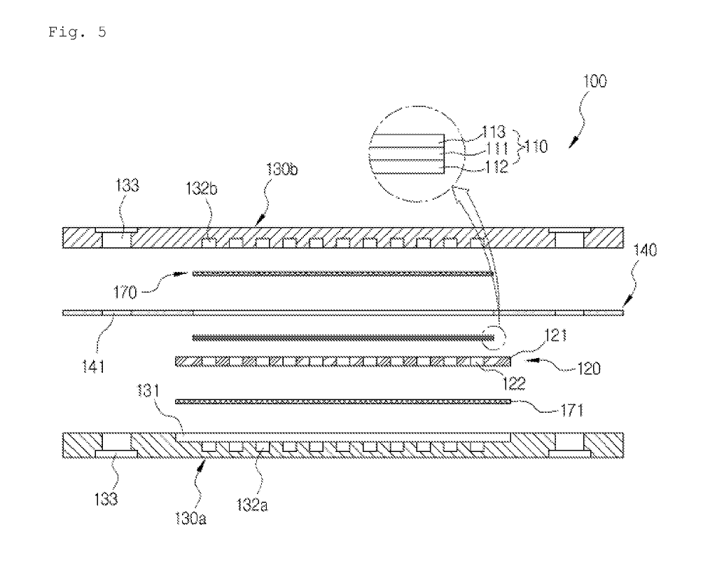

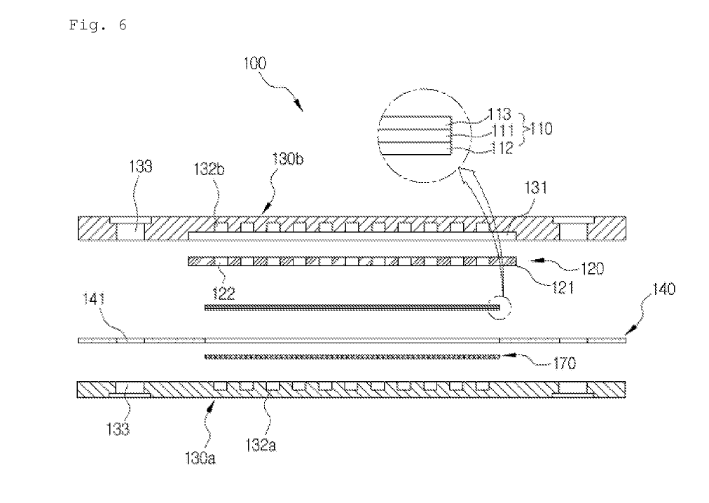

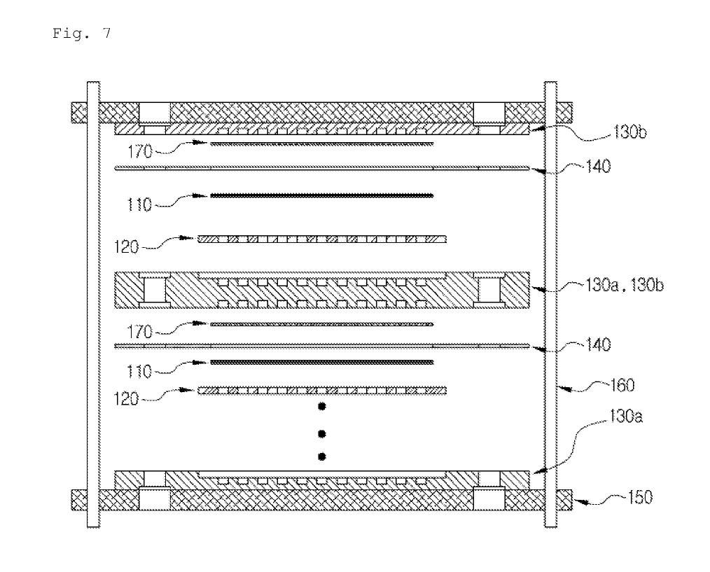

[Detailed Description of Main Elements]

| | |
|---|---|
| 100: metal supported solid oxide fuel cell | |
| 110: unit cell | 111: electrolyte layer |
| 112: anode | 113: cathode |
| 120: metal supporter | 121: welding portion |
| 122: hollow portion | |
| 130a,130b: separation plate | 131: receiving portion |
| 132a,132b: supplying passage | 133: fixing portion |
| 140: insulating member | 141: fixing portion |
| 150: end plate | 160: coupling member |
| 170: first current collecting member | |
| 180: second current collecting member | |

1. A metal supported solid oxide fuel cell (SOFC), comprising:
a unit cell 110 which comprising an electrolyte layer 111, and an anode 112 and a cathode 113 formed at both surface of the electrolyte layer 111;
a metal supporter 120 which is formed at one side of the unit cell 110;
a first current collecting member 170 which is provided at the other side of the unit cell 110; and
first and second separation plates 130a and 130b which respectively have a supplying passage 132b for supplying air to the cathode 113 and a supplying passage 132a for supplying fuel gas to an anode 112, and which are coupled with each other so that the metal supporter 120, the unit cell 110 and the current collecting member 170 are disposed therebetween,
wherein the metal supporter 120 is welded to the first or second separation plates 130a or 130b.

2. The metal supported SOFC of claim 1, wherein the metal supporter 120 has a welding portion 121 which is formed into a plate type and of which an outer circumference is welded to the first or second separation plate 130a or 130b, and a hollow portion 122 which is hollowed upward and downward at an inside of the welding portion 121 so that fuel gas or air introduced through a supplying passage 132a, 132b of the first or second separation plate 130a or 130b is supplied to the unit cell 110.

3. The metal supported SOFC of claim 2, wherein the first or second separation plate 130a or 130b has a receiving portion 131 formed at an upper side of the supplying passage 132a, 132b that the metal supporter 120 is formed, so as to be inwardly stepped.

4. The metal supported SOFC of claim 3, wherein the metal supporter 120 forms a path through which the hollow portion 122 is communicated with the supplying passage 132a, 132b of the first or second separation plate 130a, 130b.

5. The metal supported SOFC of claim 3, wherein the hollow portion 122 is formed in plural.

6. The metal supported SOFC of claim 1, further comprising an insulating member 140 provided at a portion that the first and second separation plates 130a and 130b are contacted with each other.

7. The metal supported SOFC of claim 6, further comprising a second current collecting member 171 between the metal supporter 120 and the first or second separation plate 130a or 130b.

8. The metal supported SOFC of claim 7, wherein the metal supported SOFC 100 is stacked and formed into a stack type.

9. The metal supported SOFC of claim 2, further comprising an insulating member 140 provided at a portion that the first and second separation plates 130a and 130b are contacted with each other.

10. The metal supported SOFC of claim 3, further comprising an insulating member 140 provided at a portion that the first and second separation plates 130a and 130b are contacted with each other.

11. The metal supported SOFC of claim 4, further comprising an insulating member 140 provided at a portion that the first and second separation plates 130a and 130b are contacted with each other.

12. The metal supported SOFC of claim 5, further comprising an insulating member 140 provided at a portion that the first and second separation plates 130a and 130b are contacted with each other.
